(19) United States
(12) Patent Application Publication
(10) Pub. No.: US 2017/0011071 A1
(43) Pub. Date: Jan. 12, 2017

(54) SYSTEMS AND METHODS TO GENERATE CONTACT DATABASES AND SIMULATE AND DISPLAY CONTACT VALUE PROFILES BASED ON QUANTITATIVE LEADS-BASED ANALYSIS

(71) Applicant: Tenzingbrook Software LLC, New Canaan, CT (US)

(72) Inventor: Steven Strom, New Canaan, CT (US)

(21) Appl. No.: 15/205,905

(22) Filed: Jul. 8, 2016

Related U.S. Application Data
(60) Provisional application No. 62/190,597, filed on Jul. 9, 2015.

(51) Int. Cl. G06F 17/30; G06Q 10/06

(52) U.S. Cl. CPC G06F 17/30289; G06F 17/30598; G06F 17/3053; G06Q 10/06395; G06Q 10/06311

(57) ABSTRACT

Embodiments of the invention relate generally to database generation and organization and, more particularly, to the generation and quantitative analysis of contact databases based on a contact's business leads. The system and method generate a contact database and contact value profiles using three separate modules in order to rank the contacts by the quality of the leads and notify a user when to get in touch with the contact. The system and method include a non-transitory computer readable medium that includes a contact database generation module, a contact frequency assignment module, a lead entry module, and a contact value profile simulation module. A user can enter in contact information and lead attributes. Lead attributes can include a lead quality to provide a subjective measure of the quality of the lead and a lead value to provide an objective financial measure of the value of the lead.

### CROSS-REFERENCE TO RELATED APPLICATIONS

This application claims priority to and the benefit of, co-pending U.S. Provisional Patent Application Ser. No. 62/190,597 filed on Jul. 9, 2015, the full disclosure of which is hereby incorporated by reference herein for all purposes.

### BACKGROUND OF THE INVENTION

Field of the Invention

Embodiments of the invention relate generally to database generation and organization and, more particularly, to the generation and quantitative analysis of contact databases.

Description of Related Art

Individuals and companies across a wide range of industries seek ways to manage contacts and produce value from contact databases beyond the value of possessing raw data. Current attempts to accomplish these goals fall short for a number of reasons. First, some individuals and companies develop alphabetized lists of customers, clients, and partner entities. These lists may provide a way for a searcher to find an entry if a name is already known. This practice, however, does not provide a user with useful metrics regarding the quality of contacts, for example, in terms of leads to potential business generated by each contact. In addition, enterprise versions of contact databases often are inaccessible to everyday employees. Indeed, many enterprise-level contact databases must be managed by dedicated corporate Information and Technology (IT) employees, and even inputting basic information regarding important items, such as lead generation, cannot be done easily. These customer relationship management (“CRM”) systems rose to prominence only for their ability to store massive amounts of data. CRM systems, however, fail to present that data to users in convenient and useful ways. Because of these deficiencies, present attempts to manage, analyze, and derive value from contacts are highly complicated and deliver little in the way of utility.

### SUMMARY OF THE INVENTION

Applicant has recognized the need for a high-quality and enhanced tool that allows a user to generate a contact database, simulate the value of contacts within the database, and display specific performance metrics. In particular, Applicant has recognized the need to provide users of a contact database with useful and practical metrics to analyze contacts in the database. In addition, Applicant has recognized that most employees of companies with large contact databases are not able to access or generate reports from these databases without IT assistance. Moreover, Applicant further has recognized that the reports that are generated often include nothing more than alphabetized lists and provide end users with little value.

Having recognized these and other problems, Applicant has invented systems, tangible computer-readable media, and methods to collect data, generate contact databases, and simulate contact value profiles. Embodiments can include one or more processors, one or more input and output units in communication with the one or more processors, and one or more displays. Embodiments further can include tangible computer-readable medium in communication with the one or more processors. It will be understood by one skilled in the art that it is within the scope of the invention to make and use the tangible computer-readable medium as part of a broader system or as a standalone product.

In either case, the tangible computer-readable medium can have stored therein a plurality of operational modules. Each of the operational modules can include a set of instructions that when executed cause the one or more processors to perform operations. Here, too, it will be understood by one skilled in the art that the operations described as being performed by the one or more processors can be performed as part of a method within the scope of the invention. Likewise, it is within the scope of the invention for the operations to be performed when sets of instructions are executed by a respective plurality of dedicated operational modules as described further herein.

For example, in embodiments, the plurality of operational modules can include a contact database generation module configured to receive contact data for one or more contacts. Contacts are people or organizations who have a relationship with the user and the user obtains their contact information for business or personal purposes. Contact information can include a phone number, the name of the contact, the location, the title, the company that the contact works for, and other similar information related to the particular contact and their business relationships. An example of a contact includes someone that a user meets at a social function and the user determines that the contact would perhaps generate a lead for potential business. A contact interaction can occur simply by meeting in person, or other ways such as over the phone or by e-mail. Information about the contact can be taken from e-mails received from the contact and automatically placed into the contact database that is generated.

The contact database generation module thereby can generate a contact database that can include contact information associated with the one or more contacts. The plurality of operational modules further can include a contact frequency assignment module responsive to the contact database generation module. The contact frequency assignment module can be configured to receive a contact frequency for the one or more contacts. Hence, the contact frequency assignment module can assign a suggested contact frequency to each of the one or more contacts. In embodiments, a contact alert module can alert a user to contact a designated contact at time intervals corresponding to the suggested contact frequency associated with the designated contact.

In embodiments, the plurality of operational modules further can include a lead entry module configured to receive one or more lead attributes. For example, the one or more lead attributes can include one or more of a lead type to categorize a lead (such as for example, given lead or received lead), a lead name to associate the lead with a contact, and a lead description to provide miscellaneous information associated with the lead. Lead attributes further can include a lead quality to provide a subjective measure of the quality of the lead and a lead value to provide an objective financial measure of the value of the lead.

In embodiments, the plurality of operational modules further can include a contact value profile simulation module responsive to the contact database generation module and the lead entry module. The contact value profile simulation module can be configured to generate a contact value profile for each of the one or more contacts. Each contact value profile can include one or more contact attributes. For example, contact attributes can include one or more of the lead value of each lead associated with each of the one or more contacts, the number of leads associated with each of the one or more contacts, and the lead quality of each lead associated with each of the one or more contacts. In embodiments, contact attributes further can include an objective dollar value associated with a contact. The dollar value can be obtained by summing the values of the individual leads associated with the contact.

Once a contact value profile has been generated for each contact, a contact ranking module can rank the one or more contacts based on one or more of the contact attributes. For example, contacts can be ranked by the total number of leads given or received. Contacts also can be ranked according to the dollar value of leads received by the contact or by the average quality of leads received by the contact. In embodiments, some combination of these contact attributes can be used to rank contacts.

In addition, the user can design a customized weighting based on the date to generate a universal contact score. The user can assign weight to values such as the dollar value that the contact represents, the number of leads and the quality of the lead. The user can also select a separate weight for a given or received leads. These weighted values are used to determine the universal contact score in order to determine rank of the contact.

In addition, the activity of a user can be compared with the interactions of contacts of the user via a social network. For example, a user can determine the user's Market Share of Sent Leads by dividing the total leads sent by the user for a given period (90 days) by the total leads received by all contacts in the users networks (when connected via a common social network). Other metrics also can be calculated and displayed on a user's profile in a social network to make that particular user more appealing to other members of the social network by displaying the user's proclivity to provide useful leads and be associated with contacts that are frequent senders and receivers of leads. The metrics can include one or more of the following: (a) User Network Activity, which includes the total leads sent and received by all contacts of a user for a specific period of time; (b) User Activity, which includes the total number of leads sent and received by a user in a specific period of time; (c) Percentage of Leads Sent, which can be derived by taking total leads sent by a user and dividing by total leads sent and received by the user (e.g., for specific periods of time); (d) Market Share of Leads Given, which includes total leads sent by a user divided by all leads received by all the contacts of a user in a specific period of time; (e) Most Recent Activity for Given or Received Leads, which is the time post of the most recently sent or received leads as recorded by the user; (f) Trending Activity, which can be calculated using a dollar value or a count of leads given or received, and which compares a user's leads sent or received for a recent period versus a prior period (e.g., this month versus last month); (g) Total Contact Interaction, which includes the number of contacts to whom the user has sent leads in a specific period (i.e., measuring the number of contacts, not the number of leads). Displaying these metrics on a selective basis to others in a social network enables the user to exhibit their attractiveness as a contact and also can be a fun game for people trying to maximize their network of contacts and referrals from said contacts. This data also can be sold or otherwise utilized by a social network for users who want to see how their metrics rank versus their own contacts as well as other users from competing firms, similar schools, or with comparable backgrounds.

### BRIEF DESCRIPTION OF THE DRAWINGS

FIGS. 1 and 2 are schematics of an example of a system as described herein.

FIGS. 3, 4, and 5 are screen shots of a device employing an example of a method and system described herein.

### DETAILED DESCRIPTION OF THE INVENTION

So that the manner in which the features and advantages of the embodiments of systems, apparatuses, methods, and non-transitory computer-readable media having computer program stored therein of the present invention, as well as others, which will become apparent, may be understood in more detail, a more particular description of the embodiments of the present invention briefly summarized above may be had by reference to the embodiments thereof, which are illustrated in the appended drawings, which form a part of this specification. It is to be noted, however, that the drawings illustrate only various embodiments of the embodiments and, therefore, are not to be considered limiting of the embodiments of the present invention's scope as the invention includes other effective embodiments as well.

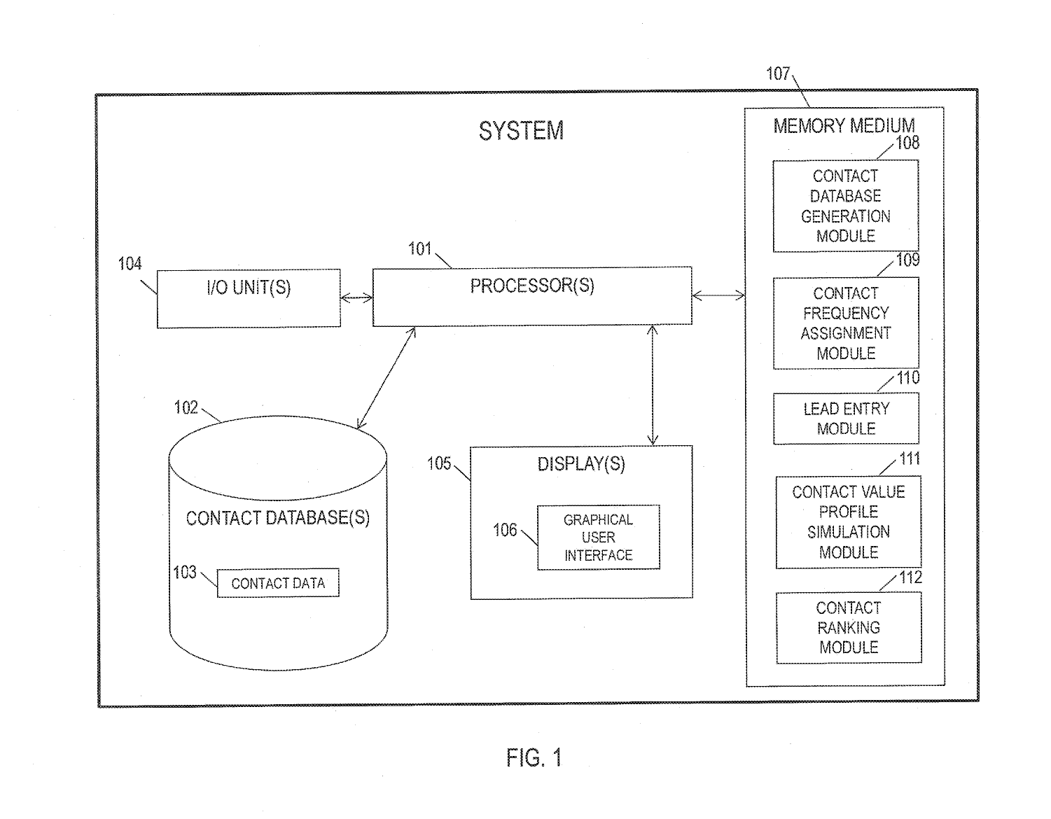

Various embodiments of the invention can include systems, tangible computer-readable media, and computer-implemented methods to generate contact databases and simulate contact value profiles. Shown in FIG. 1 is an embodiment of the invention. Embodiments can include one or more processors 101, one or more input and output units 104 in communication with the one or more processors 101, and one or more displays 105. Embodiments further can include tangible computer-readable medium 107 in communication with the one or more processors 101. It will be understood by one skilled in the art that it is within the scope of the invention to make and use the tangible computer-readable medium 107 as part of a broader system or as a standalone product.

In either case, the tangible computer-readable medium 107 can have stored therein a plurality of operational modules. Each of the operational modules can include a set of instructions that when executed cause the one or more processors 101 to perform operations. Here, too, it will be understood by one skilled in the art that the operations described as being performed by the one or more processors 101 can be performed as part of a computer-implemented method within the scope of the invention. Likewise, it is within the scope of the invention for the operations to be performed when sets of instructions are executed by a respective plurality of dedicated operational modules as described further herein.

For example, in embodiments, the plurality of operational modules can include a contact database generation module 108 configured to receive contact data for one or more contacts. Contact data can be received in a number of ways. Some non-limiting examples are mentioned here. For example, contact data can be received by manual input. Thus, a user can employ a graphical user interface 106 on a display 105 in order to enter a contact name, contact business, and other identifying information for a contact. Other fields can be included as well, including custom fields created by the user. For example, a user can include a custom field for a contact's profession (e.g., attorney, doctor, executive, etc.), school, or any other classification of interest. The contact database generation module 108 also can receive contact data from an existing database. A contact can occur at a social function, in person, via e-mail, or phone call. The contact can also occur through a referral or social network site. Other methods of obtaining a contact are also envisioned in the invention, such as routine interactions online or message boards.

For example, in embodiments implemented on a smartphone, computer, laptop, ipad, other personal digital assistant (“PDA”), or the like, the one or more processors 101 can correspond to the smartphone's one or more processors and the memory medium 107 can correspond to the smartphone's memory medium or any other memory medium in communication with the smartphone's processors. Thus, the memory medium 107 can have stored therein a user's existing contact data. It follows that, in embodiments, the contact database generation module 108 can receive contact data from the user's existing contact data to generate a contact database 102 for purposes of generating contact value profiles. In addition, the contact database generation module 108 can receive contact data from another party's existing database. For example, a “share” function can allow the user of one smartphone to share contact data with the user of another smartphone, thereby allowing the user of the second smartphone to import contact data directly from the first user's contact list into his or her own contact database 102 where the imported contact data 103 is stored. Therefore, in a variety of ways, the contact database generation module 108 can generate one or more contact databases 102 that can include contact information associated with the one or more contacts.

The plurality of operational modules further can include a contact frequency assignment module 109 responsive to the contact database generation module 108. The contact frequency assignment module 109 can be configured to receive a contact frequency for the one or more contacts. For example, when contact data 103 is input initially, a user can be prompted to enter a corresponding contact frequency. The contact frequency can include a suggested number of times to contact the respective contact during any predefined time period. For example, the contact frequency can be once per week, twice per month, eight times per year, etc.

It will be understood that any contact frequency can be used and that any time period, including predefined time periods and variable time periods, are within the scope of the invention. Hence, the contact frequency assignment module 109 can assign a suggested contact frequency to each of the one or more contacts. In embodiments, a contact alert module can alert a user to contact a designated contact at time intervals corresponding to the suggested contact frequency associated with the designated contact. For example, if a user has entered a contact frequency of once per week for Contact A, a push notification on the user's smartphone can alert the user once per week to contact Contact A. A push notification is an alert that is sent to either a user's text, email or displayed through the actual contact application itself that alerts the user about an event that has happened related to the application. The user can set and modify the time for these weekly notifications. For example, a user can set the contact alert module to generate all of the day's alerts in the morning. In embodiments, the user can set the contact alert module individually for each contact, such that, for example, the user receives an alert every Tuesday morning to contact Contact A and every Thursday at lunch to contact Contact B. As an alternative or in addition to being responsive to a time frequency, an alert can be responsive to the occurrence of an event. For example, the contact alert module can be configured to generate a push notification or other alert to contact one or more contacts just before an earnings season ends, after an awards show, or after a contact's alma mater plays the user's alma mater in a sports competition.

In embodiments, the plurality of operational modules further can include a lead entry module 110 configured to receive one or more lead attributes. A lead, as used herein, can refer to any information regarding a business opportunity or any information that could be considered useful in making a business decision. Leads also can include introductions or referrals to third persons or corporations that have value for a user's career. For example, a lead can include information that can be used to seek a business gain, or information that can be used to avoid a loss. For instance, if a user is in need of a loan, a useful lead can include the name and contact information for a loan officer who specializes in loans of the type and in the industry in which the user is interested. As another example, a user may be a developer who wishes to buy land on which to build a mall. A lead may be information from a second developer concerning the second developer's return on investment from building in the same area. As yet another example, a user can be an actor in search of a film role. For the actor, a lead can include an introduction to a well-known director or producer. It will be understood that the term “lead” broadly encompasses a variety of information that pertains to a user's business interests.

As noted above, the lead entry module 110 can be configured to receive one or more lead attributes, or characteristics of a lead. The one or more lead attributes can include one or more of a lead direction to note whether a lead was given or received, a lead type to categorize a lead, a lead name to associate the lead with a contact, and a lead description to provide miscellaneous information associated with the lead. For example, a lead type can include any number of categories. Some non-limiting examples include referral and introduction as noted above. A lead name can associate the lead with a given contact.

A lead can be associated with more than one contact as well. For example, if a user has lunch with colleagues and receives valuable information during the lunch, the user can enter a lead and enter each colleague as being associated with the lead. Other miscellaneous information regarding the lead can be entered, including, for example, that the lead was shared over lunch or at a particular sporting event. Lead attributes further can include a lead quality to provide a subjective measure of the quality of the lead and a lead value to provide an objective financial measure of the value of the lead. For example, a lead quality can include a value from 1 to 10 to measure subjectively the value of a lead. A very valuable referral can receive a lead value of 10 for example. If, on the other hand, an introduction that yields nothing for a user's business interests, the user can assign a quality of 1 to the respective lead entry documenting that introduction.

In addition, lead attributes can include an objective financial measure of the value of the lead, i.e. a lead value. The lead value can be in addition to or as an alternative to the lead quality. As an example, an actor can receive a lead in the form of an introduction to a director. If the introduction develops into a lucrative movie role, the actor can input the total earnings from that movie role as the value of the introduction lead. In other cases, a financial value can be difficult to estimate, and it can be preferable to use only the quality score for that particular lead. For instance, a developer can be told by a contact that the contact has lost a lot of money investing in downtown properties. While it might be difficult to determine the exact financial value of this lead from the developer's perspective, the developer may consider the quality of this lead to be a 10 nonetheless. Thus, the developer can assign the lead a quality of 10, but leave the value field blank. In other cases, the developer can assign a value based on the developer's best estimate of what his or her loss would have been in the absence of such information.

In addition, certain lead attributes can be assigned. For example, a user can input a lead given but assign some or all of the lead details to the recipient for follow-up. The user can then receive updates from the recipient, either via an internal network, a social network as discussed in more detail below, or other means. That is, the recipient later can input that the lead resulted in a sale. The recipient also can enter a lead quality and a lead value. For example, the recipient can input a quality of 10 and a lead value of $100,000. The user who gave the lead will have this lead updated via the means discussed above. The update can take the place of placeholder data or fill in blank fields.

In embodiments, the plurality of operational modules further can include a contact value profile simulation module 111 responsive to the contact database generation module 108 and the lead entry module 110. The contact value profile simulation module 111 can be configured to generate a contact value profile for each of the one or more contacts. Each contact value profile can include one or more contact attributes. For example, contact attributes can include one or more of the lead value of each lead associated with each of the one or more contacts, the number of leads associated with each of the one or more contacts, and the lead quality of each lead associated with each of the one or more contacts. In embodiments, contact attributes further can include an objective monetary (or dollar) value associated with a contact. The monetary value can be obtained by summing the values of the individual leads associated with the contact.

Once a contact value profile has been generated for each contact, a contact ranking module 112 can rank the one or more contacts based on one or more of the contact attributes. For example, contacts can be ranked by the total number of leads given or received. Contacts also can be ranked according to the monetary value of leads received by the contact or by the average quality of leads received by the contact. In embodiments, some combination of these contact attributes can be used to rank contacts.

In embodiments, the plurality of operational modules further can include a report module. The report module can generate reports, either on command or according to predetermined settings. For example, a user can program the report module to generate weekly or monthly reports. The reports can be generated, and a user can be notified via a push notification or in another manner. For example, reports can be displayed on the one or more displays 105.

Reports can display who a user's most valuable contacts are for each direction (given or received) of leads. For example, a user can see who his or her most valuable contacts are, and a user also can see to which contacts the user is providing the most value. The report module can generate a report with information derived from the contact ranking module. For example, a report can show who the most valuable contacts are when ranked by one or more of (i) period of time, (ii) quality, (iii) quantity, and (iv) monetary value. A report also can show from which companies a user is giving or receiving the most leads. Again, the companies can be ranked according to quantity, quality, or monetary value, and for different time periods. For example, a user can see which company's employees provided the user with the highest quality leads in the last month. As another example, a user can see to which company's employees the user has provided the most leads to in the last year. A user further can view the total amount of all leads given or received to all contacts. Again, the total can be for a given time window, such as the last week, or last June. The total can also refer to the number of leads, the quality of leads, the dollar value of leads, some other attribute, or any combination of these. Thus, the user will have at his or her disposal tools to organize and monetize leads more efficiently. In one alternate embodiment, a trend, or what contact is currently “trending”, is generated using the system and method herein described. In one example, the trend indicates the number of leads (and any lead attributes) that occur from a particular contact; where the trend can occur over any time period, i.e. week(s), month(s), year(s), and combinations thereof.

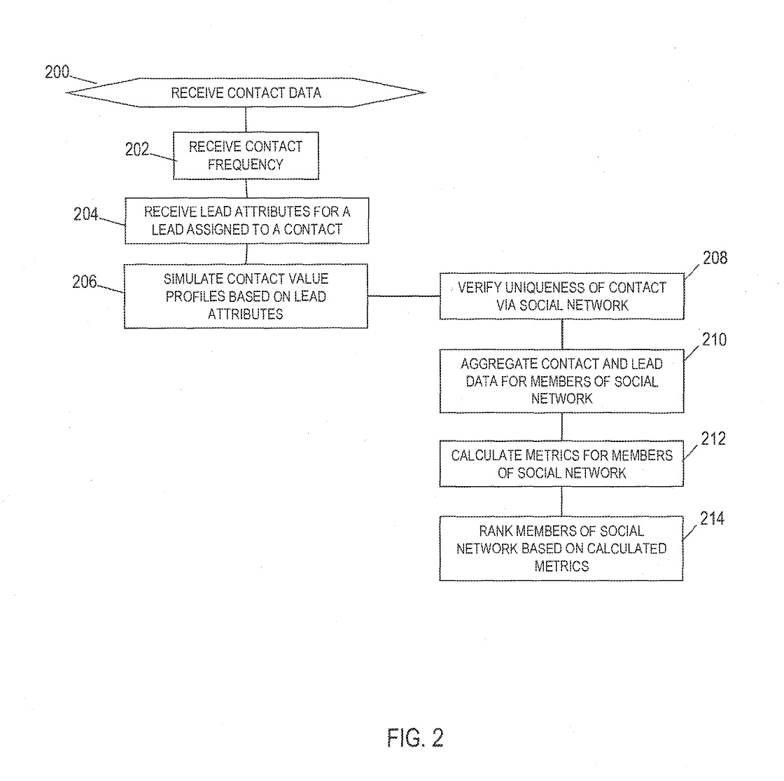

According to embodiments of the invention, the aforementioned modules can operate as the front-end data collection for purposes of using the data in a social network setting, as shown, for example, in FIG. 2. For example, a method can include receiving contact data 200, receiving contact frequency 202, receiving lead attributes for a lead assigned to a contact 204, and generating contact value profiles based on lead attributes 206. Each of these steps can be performed as described in previous sections. In addition, however, the collected data can be used in a social network. In this setting, a user may want to compare his statistics with the those of his contacts. For example, Alfred and Billy might each know Charlie. Alfred might want to know how the number of leads he has given to Charlie compares to the number of leads Billy has provided to Charlie. With some of the above techniques, Alfred can confirm that he has given more leads to Charlie than he has received from Charlie, but he cannot determine how he compares to Billy. A social network is useful in this regard because the social network can be used to verify the uniqueness of a contact's identity. That is, to obtain useful metrics, Alfred needs to know that the Charlie in his contacts is the same Charlie in Billy's contacts. Once the identity is verified as unique, the contact and lead data that Alfred and Billy have respectively input themselves with respect to Charlie can be aggregated and compared. The operator of the social network or a third-party aggregator of the data can then determine that Alfred gives more leads to Charlie than Billy does. If the social network includes only these three individuals and only Alfred and Billy have generated contact databases as described herein, then the social network can rank Alfred as first and Billy as second in terms of leads given to Charlie. If Dale joins the social network, he might be interested in first connecting with people that give out the most leads. In that event, Alfred could be shown higher in search results, either by default or responsive to Dale's request that the members be ranked by search results.

This presents just one example of how the described techniques can be integrated with a social network. More generally, a social network can be used to verify the uniqueness of contacts 208. Then, the social network or an aggregator given permission can aggregate contact and lead data for members of the social network 210. After aggregating data, a method can include calculating metrics for members of the social network 212. In the example above, a very specific metric was offered: who had given more leads to Charlie. It will be clear that any number of metrics are within the scope of the invention.

For example, the metrics can include one or more of the following: (a) User Network Activity, which includes the total leads sent and received by all contacts of a user for a specific period of time; (b) User Activity, which includes the total number of leads sent and received by a user in a specific period of time; (c) Percentage of Leads Sent, which can be derived by taking total leads sent by a user and dividing by total leads sent and received by the user (e.g., for specific periods of time); (d) Market Share of Leads Given, which includes total leads sent by a user divided by all leads received by all the contacts of a user in a specific period of time; (e) Most Recent Activity for Given or Received Leads, which is the time post of the most recently sent or received leads as recorded by the user; (f) Trending Activity, which can be calculated using a monetary value or a count of leads given or received, and which compares a user's leads sent or received for a recent period versus a prior period (e.g., this month versus last month); (g) Total Contact Interaction, which includes the number of contacts to whom the user has sent leads in a specific period (i.e., measuring the number of contacts, not the number of leads).

In embodiments, methods then can include ranking members of the social network based on the calculated metrics 214. For example, a user may want to rank his social network contacts based on Market Share of Leads Given as defined above. Thus, by integrating the above techniques with a social network, members of the social network can be ranked according to one or a combination of the above metrics, as well as other metrics that will be apparent to one of skill in the art upon reading this disclosure.

In embodiments, a user can be given control over which of his own metrics to display. For example, a user of a professional social network may wish to signal his attractiveness as a professional connection to others. To do so, he might display on his social network profile the total number of leads he or she has sent over a specified period of time (e.g., the last three months). In embodiments, all metrics can be hidden from users of the social network. For example, the operator of the social network can simply assign weights to the various metrics and cause members to move up or down in search results responsive to the metrics.

For instance, if a new entrant to the social network searches for Evan, a number of results might appear. These results can be alphabetical by default. But if Evan Robertson's contacts overwhelmingly input that they have received valuable leads from Evan Robertson, and Evan Johnson's contacts overwhelmingly input that they give leads to Evan Johnson but do not receive any, then Evan Robertson might appear at the top of the list, out of alphabetical order and ahead of Evan Johnson and others who would be viewed as unattractive connections in a professional network. Again, this is simply an example of how the aggregated data can be used to calculate metrics and how the metrics can be used to rank contacts. It will be apparent to one of skill in the art that the disclosed techniques provide additional valuable information for people skilled in assessing social networks and business development networking. It should be pointed out that a social network can include any collection of users accessing a web like system. For example, a social network can include a public social network where any user seeking to join is afforded access (e.g. Facebook®, LinkedIn®, etc.).

A social network includes those that are restricted, such as within a corporation's intranet, a university, or other association. In an alternative, a user can generate a list all leads, including given and received, and where a contact or contacts associated with each of the leads is displayable with the listing of all of the leads. This listing is optionally referred to as a “reverse lookup”, which is a tool that a user can find valuable as a way to identify contacts that are associated with the leads. An advantage of listing leads that are given is that if an imbalance to a particular contact is identified, the imbalance can be presented to the identified particular contact with a request to reciprocate the leads. Thus an underutilized resource can be identified and leveraged for business advantage.

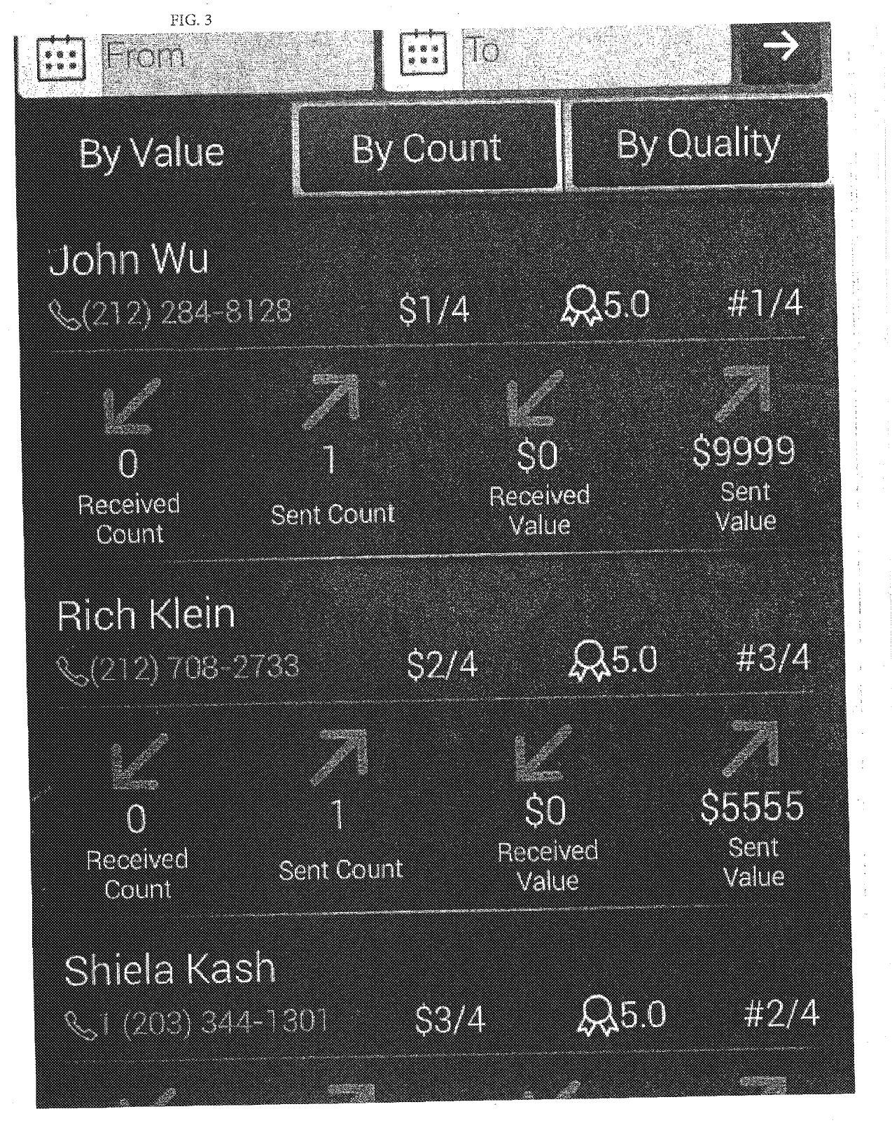

FIG. 3 shows an embodiment of the main contact screen in the application. This screen includes a date filter, that will sort out the contacts that were contacted or added during a certain set of dates, and contacts can be sorted by lead value, count and quality. The value, count, and average quality of the leads for each contact is shown in FIG. 3, along with the name of the contact, the phone number of the contact, the total leads received, the total leads sent, the total received value of the leads and the total sent value of the leads.

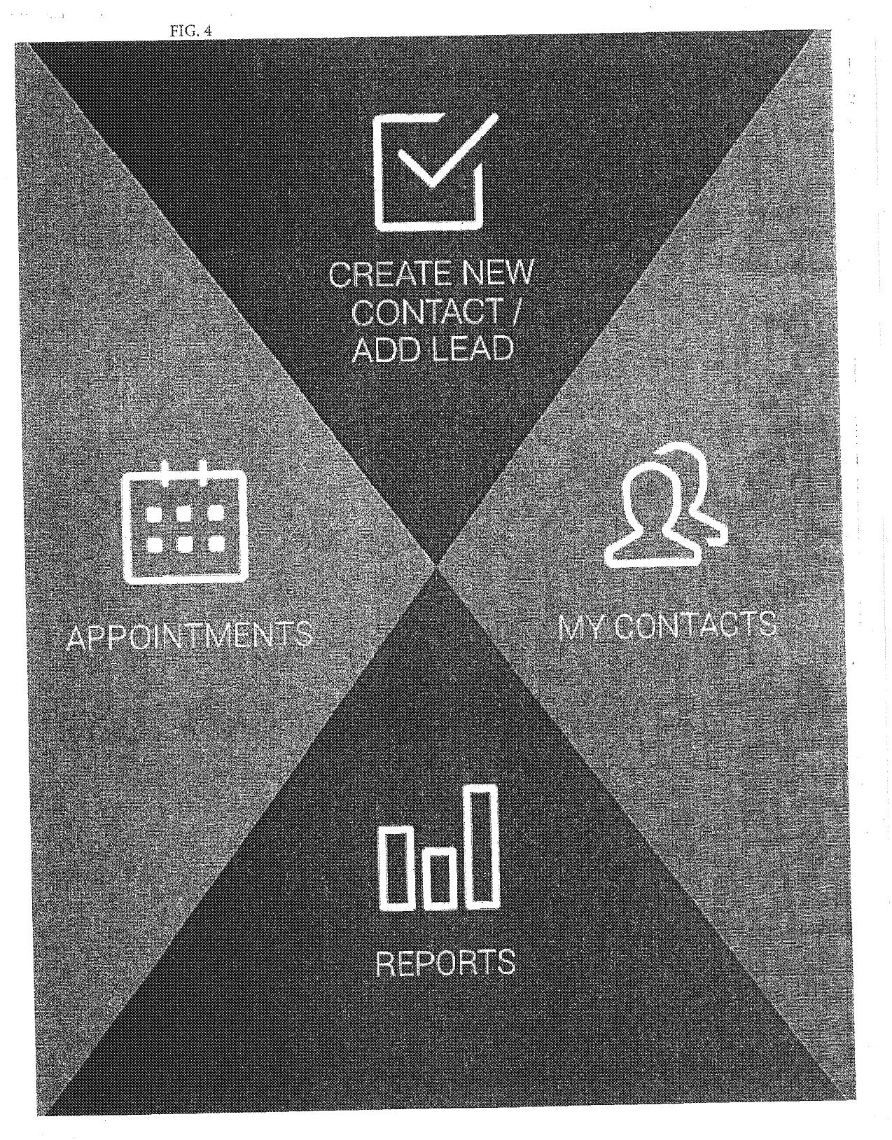

FIG. 4 shows the main screen of an embodiment of the invention. A user can choose one of the four options through input means including a touch screen and the like in order to perform tasks such as creating a new contact or adding a lead to an existing contact, accessing the user's contacts, accessing reports concerning the leads and contact statistics or adding an appointment for each contact. Embodiments of the invention have various setups for the buttons.

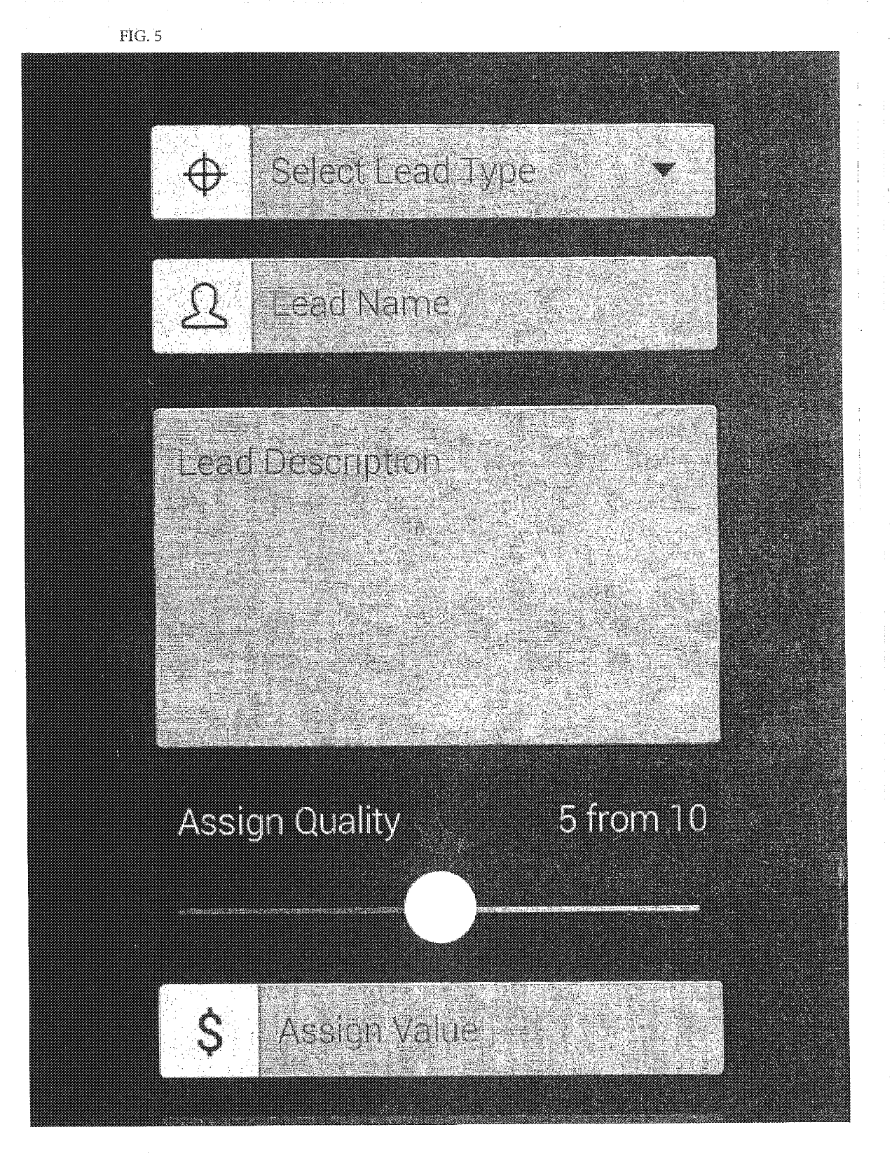

FIG. 5 shows the screen for adding a lead to a contact. The lead includes type of leads, the lead name and lead description along with a quality of lead slider bar from 0-10 and a lead dollar value entry location. As discussed above, multiple input means can be used to input the information other than that shown in FIG. 5.

In the various embodiments of the invention described herein, a person having ordinary skill in the art will recognize that various types of memory are readable by a computer, such as the memory described herein in reference to the various computers, e.g., computer, computer server, web server, microcontroller, system-on-chip, application-specific integrated circuit, or other computers with embodiments of the present invention. Examples of computer-readable media can include but are not limited to: nonvolatile, hard-coded type media, such as read only memories (ROMs), CD-ROMs, and DVD-ROMs, or erasable, electrically programmable read only memories (EEPROMs); recordable type media, such as floppy disks, hard disk drives, CD-R/RWs, DVD-RAMs, DVD-R/RWs, DVD+R/RWs, flash drives, memory sticks, and other newer types of memories; and transmission type media such as digital and analog communication links. For example, such media can include operating instructions, as well as instructions related to the systems, apparatuses, computer media, and the method steps described above and can operate on a computer. It will be understood by those skilled in the art that such media can be at other locations instead of, or in addition to, the locations described to store computer program products, e.g., including software thereon. It will be understood by those skilled in the art that the various software modules or electronic components described above can be implemented and maintained by electronic hardware, software, or a combination of the two, and that such embodiments are contemplated by embodiments of the present invention.

In the drawings and specification, there have been disclosed embodiments of methods, systems, and non-transitory computer-readable medium having computer program stored therein of the present invention, and although specific terms are employed, the terms are used in a descriptive sense only and not for purposes of limitation. Embodiments of the present invention have been described in considerable detail with specific reference to illustrated embodiments. It will be apparent, however, that various modifications and changes can be made within the spirit and scope of the embodiments of the present invention as described in the foregoing specification, and such modifications and changes are to be considered equivalents and part of this disclosure. Moreover, it is noted that various features of the invention described with respect to certain embodiments are to be imputed to other embodiments as well unless specifically stated otherwise.

That claimed is:

1. A system to generate a contact database and generate contact value profiles, the system comprising:
one or more processors;
one or more input and output units in communication with the one or more processors;
one or more displays with windows for displaying a contact entry screen, a contact information screen, a task screen, a login screen, a home screen, and a contact list including the total leads received from the contact, the total leads sent, the received value of the leads, the sent value of the leads, and the lead rank; and
non-transitory computer-readable medium in communication with the one or more processors and having stored therein a plurality of operational modules, each operational module including a set of instructions that when executed cause the one or more processors to perform operations, the plurality of operational modules including:
a contact database generation module configured to receive contact data for one or more contacts thereby to generate a contact database including contact information associated with the one or more contacts;
a contact frequency assignment module responsive to the contact database generation module and configured to receive a contact frequency for the one or more contacts thereby to assign a suggested contact frequency to each of the one or more contacts;
a lead entry module configured to receive one or more lead attributes, the one or more lead attributes including one or more of a lead type to categorize a lead, a lead name to associate the lead with a contact, a lead description to provide miscellaneous information associated with the lead, a lead quality based on a user input value to provide a subjective measure of the quality of the lead, and a lead value to provide an objective financial measure of the value of the lead; and
a contact value profile simulation module responsive to the contact database generation module and the lead entry module and configured to generate a contact value profile for each of the one or more contacts, the contact value profile including one or more contact attributes, the one or more contact attributes including one or more of the lead value of each lead associated with each of the one or more contacts, the number of leads associated with each of the one or more contacts, the lead quality of each lead associated with each of the one or more contacts, and a user-generated universal contact score, designed by a user creating a customized weighting of a dollar value of each contact lead, a number of leads for the contact, and a quality of the lead.

2. A system as defined in claim 1, wherein the contact database generation module further is configured to receive contact data from a preexisting database, wherein the plurality of modules further includes a contact alert module responsive to the contact frequency assignment module and configured to alert a user to contact a designated contact at time intervals corresponding to the suggested contact frequency associated with the designated contact.

3. A system as defined in claim 2, wherein the contact alert module further is configured to alert a user to contact the designated contact upon occurrence of an event associated with the designated contact.

4. A system as defined in claim 2, wherein the plurality of modules further includes a contact ranking module responsive to the contact value profile simulation module and configured to rank the one or more contacts algorithmically based on one or more of the contact attributes.

5. A system as defined in claim 4, wherein the plurality of modules further includes a report modules responsive to the contact ranking module and configured to generate one or more reports on the one or more displays, the one or more reports including ranking information for the one or more contacts.

6. A method to generate a contact database and simulate contact value profiles, the method comprising:
receiving contact data for one or more contacts thereby to generate a contact database including contact information associated with the one or more contacts;
receiving a contact frequency for the one or more contacts thereby to assign a suggested contact frequency to each of the one or more contacts;
receiving one or more lead attributes, the one or more lead attributes including one or more of a lead type to categorize a lead, a lead name to associate the lead with a contact, a lead description to provide miscellaneous information associated with the lead, a lead quality based on a user input value to provide a subjective measure of the quality of the lead, and a lead value to provide an objective financial measure of value of the lead;
generating a contact value profile for each of the one or more contacts, the contact value profile including one or more contact attributes, the one or more contact attributes including one or more of the lead value of each lead associated with each of the one or more contacts, the number of leads associated with each of the one or more contacts, the lead quality of each lead associated with each of the one or more contacts, and a user-generated universal contact score, designed by a user creating a customized weighting of a dollar value of each contact lead, a number of leads for the contact, and a quality of the lead; and
displaying a contact entry screen, a contact information screen, a task screen, a login screen, a home screen, and a contact list to a user.

7. A method as defined in claim 6, wherein receiving contact data includes receiving contact data from a preexisting database, and wherein the method further comprises alerting a user to contact a designated contact at time intervals corresponding to the suggested contact frequency associated with the designated contact.

8. A method as defined in claim 7, wherein alerting the user to contact the designated contact includes alerting the user to contact the designated contact upon occurrence of an event associated with the designated contact.

9. A method as defined in claim 7, the method further comprising the step of ranking the one or more contacts algorithmically based on the one or more contact attributes.

10. A method according to claim 9, the method further comprising the step of generating one or more reports, the one or more reports including contact ranking information.

11. A system to generate a contact database and generate contact value profiles, the system comprising:
one or more processors;
one or more input and output units in communication with the one or more processors;
one or more displays for a user with windows for displaying a contact entry screen, a contact information screen, a task screen, a login screen, a home screen, and a contact list including the total leads received from the contact, the total leads sent, the received value of the leads, the sent value of the leads, and the lead rank; and
non-transitory computer-readable medium in communication with the one or more processors and having stored therein a set of instructions that when executed cause the one or more processors to perform operations including:
generating a contact value profile for each of one or more contacts, wherein the contact value profile includes one or more contact attributes, the one or more contact attributes including one or more of the lead value of each lead associated with each of the one or more contacts, the number of leads associated with each of the one or more contacts, the lead quality of each lead associated with each of the one or more contacts, and a user-generated universal contact score, designed by a user creating a customized weighting of a dollar value of each contact lead, a number of leads for the contact, and a quality of the lead; and
comparing a user profile with other contacts via a social network and selectively displaying on the displays the compared values including a user activity, a user network activity, a percentage of leads sent, market share of leads given, most recent activity for given or received leads, trending activity and total contact interaction and one or more of these compared values is displayed on the contacts social network profile.

12. A system as defined in claim 11, wherein the contact database generation module further is configured to receive contact data from a preexisting database, wherein the plurality of modules further includes a contact alert module responsive to the contact frequency assignment module and configured to alert a user to contact a designated contact at time intervals corresponding to the suggested contact frequency associated with the designated contact.

13. A system as defined in claim 12, wherein the contact alert module further is configured to alert a user to contact the designated contact upon occurrence of an event associated with the designated contact.

14. A system as defined in claim 12, wherein the plurality of modules further includes a contact ranking module responsive to the contact value profile simulation module and configured to rank the one or more contacts algorithmically based on one or more of the contact attributes.

15. A system as defined in claim 14, wherein the plurality of modules further includes a report modules responsive to the contact ranking module and configured to generate one or more reports on the one or more displays, the one or more reports including ranking information for the one or more contacts.

16. A system as defined in claim 11, further including a contact database generation module configured to receive contact data for one or more contacts thereby to generate a contact database including contact information associated with the one or more contacts.

17. A system as defined in claim 11, further including a contact frequency assignment module responsive to the contact database generation module and configured to receive a contact frequency for the one or more contacts thereby to assign a suggested contact frequency to each of the one or more contacts.

18. A system as defined in claim 11, further including a lead entry module configured to receive one or more lead attributes, the one or more lead attributes including one or more of a lead type to categorize a lead, a lead name to associate the lead with a contact, a lead description to provide miscellaneous information associated with the lead, a lead quality based on a user input value to provide a subjective measure of the quality of the lead, and a lead value to provide an objective financial measure of the value of the lead.
